(19) United States
(12) Patent Application Publication
(10) Pub. No.: US 2012/0204258 A1
(43) Pub. Date: Aug. 9, 2012

(54) PASSWORD INPUT METHOD BASED ON TOUCH SCREEN

(76) Inventor: ByoungCheol LEE, Seoul (KR)

(21) Appl. No.: 13/451,603

(22) Filed: Apr. 20, 2012

Related U.S. Application Data
(63) Continuation of application No. PCT/KR2010/005802, filed on Aug. 27, 2010.

(30) Foreign Application Priority Data
Oct. 22, 2009 (KR) 10-2009-0100661
Jul. 5, 2010 (KR) 10-2010-0064265

(51) Int. Cl. G06F 21/00; G06F 7/04

(52) U.S. Cl. 726/19

(57) ABSTRACT

Disclosed is a password input method based on a touch screen, including the steps of displaying at least one background scene, generating trace data from a user's touch on the touch screen while the background scene is being displayed, comparing the trace data to password trace data preliminarily stored, and successfully terminating a password admission process if the trace data is identical to the password trace data. In entering a password by a user, even without preparing an additional input unit such as a keypad or keyboard and other similar fixed pictures (by software), this method enables a user to freely select and set a background scene in various types as well as variously forming a touch operation with his own password for admission, providing both security and input convenience of password keys.

### CROSS-REFERENCES TO RELATED APPLICATIONS

This application is a bypass continuation application of currently pending international application No. PCT/KR2010/005802 filed Aug. 27, 2010 designating the United States of America, the entire disclosure of which is incorporated herein by reference. Priorities are claimed based on Korean patent application No. 10-2009-0100661 filed Oct. 22, 2009 and on Korean patent application No. 10-2010-0064265 filed Jul. 5, 2010.

### BACKGROUND

1. Technical Field

The present invention relates generally to password input methods by touch screens, and particularly to a password input method, using a touch screen, capable of conducting password admission from comparison between predetermined trace data and trace data which is created by a user's contact on one or more background scenes in a touch screen.

2. Related Art

The description hereinafter is concerned with password input by way of touch screens.

In recent years, with respect to touch screens widely used as new input means instead of keypads, keyboards, etc. for a variety of terminals, those are highly interested by the merits of commonly utilizing display windows for input as well as output, without mechanical input units, and providing more advanced user interface environments by allowing users to act very intuitive input works.

A touch screen is a kind of screen equipped with a touch sensor panel capable of detecting a touch point to which a finger or tool contacts on a picture thereof While there have been provided various technical skills for touch screens, gradually improving recognition accuracy and response rate, its demands are rapidly increasing nowadays even to personal terminals or portable phones along higher utility for handwriting recognition or multi-touch functions.

Input operations on a touch screen basically include the functions of TAP (pressing down) pressing and releasing a specific point, and DRAG (dragging) moving a touching tip from a specific point to another point while contacting it, on a screen (touch panel), also providing other all general functions of simple key input, complex function control, and even to highly sensitive handwriting recognition.

In conventional password input schemes or units, numbers or characters line previously accepted from users are stored in a form of cryptographic keys and compared to values input through keyboards or keypads, or passwords are permitted to be applied by displaying imaginary keyboards or keypads (by software) at various types of touch screen terminals.

However, those methods for password or cryptogram input should be accompanied with an additional input unit such as a numeric keyboard or keypad in order to receive a cryptographic key from a user.

Meanwhile, in mobile terminals or portable phones equipped with touch screens instead of hardware input units, complex imaginary keyboards are displayed by software on touch screens with fixed sizes and users have to touch those keyboards, so that key inputs becomes more inconvenient to cause discord between cryptographic key security and input convenience.

For that reason, there has been proposed ‘graphic password input mode on cell picture’ progressing the input style to a touch mode. While regarded as successful in enhancing input convenience as a user is able to enter a password through a touch operation on a matrix cell in a graphic pattern, it is still insufficient to overcome the disharmony between input convenience and revivable probability in case of dividing a cell in small size and complicating a touch operation for the purpose of ensuring a desired security level.

At present, another method proposed as revision of the former two modes, which may be called ‘patterned password mode’, is conductible to input a password through a key by a user's DRAG operation at a soft keyboard or keypad displayed on a screen. Although more convenient than conventional soft keyboards, it is impossible to jointly press keys physically apart from each other, or re-input the same key. Because of that, it has other problems of lower user convenience, e.g. lower security due to a rather smaller number of cases, incapability of free combination with a password consisting of significant characters or memorizable numbers.

Hence, there is still required a new pass word input apparatus and method on a touch screen, enabling a user to set a password from a series of optional touch operation having sufficient security and then always revive the touch operation on an input unit easily and quickly.

### SUMMARY

Accordingly, the present invention is directed to a password input apparatus and method based on a touch screen without preparing an additional input unit such as a keypad or keyboard and other similar fixed pictures (by software).

The present invention is also directed to a password input method based on a touch screen, capable of coincidently achieving cryptographic key security and input convenience by admitting a password in response to a touch of a touch screen, while displaying a background scene, along a trace same as trace data corresponding to the password preliminarily stored.

The present invention is further directed to a password input method based on a touch screen, conducting a password input manner such as dragging, which is more convenient than the conventional formalized characters key input mode, by displaying an image at a predetermined area of a background scene, activating a trace of a touched point along a specific region to the displayed image, and then executing password admission to trace data.

The present invention is also directed to a password input method based on a touch screen, providing a variety of tools for password input by disposing a motion picture as well as a plurality of images displayed on a predetermined area in time series.

The present invention is further directed to a password input method based on a touch screen, inducing an interest along with higher security, when a user tries to set and enter a password, by offering a keyboard instrument with a multiplicity of fingerboards or plural percussion instruments at a predetermined area of a background scene and generating, when the user touches the fingerboards or the percussions according to a tune or rhythm, trace data containing a pattern of the tune or rhythm.

The present invention is also directed to a password input method based on a touch screen, more ensuring password admission, in response to a user's access to a corresponding menu, by executing the password admission once more to the corresponding menu when a user conducts the password admission to each of images which are displayed with two or more on a background scene in time series, or selects a menu appearing after the password admission.

The present invention is still further directed to a password input method based on a touch screen, capable of executing password admission in a condition of enlarging, scaling down or moving a background scene by a user as well as enabling the user to easily set a password necessary for the password admission by storing the password as coordinate data of a point touched by the user on the touch screen while displaying the background scene.

In an embodiment of the present invention, a password input method based on a touch screen may include the steps of displaying at least one background scene, generating trace data from a user's touch on the touch screen while the background scene is being displayed, comparing the trace data to password trace data preliminarily stored, and successfully terminating a password admission process if the trace data is identical to the password trace data.

The password trace data may be generated and stored by means of a user's touch input to the touch screen while displaying a background scene for a password setup mode.

The background scene may be changed and stored by a user's setup.

The background scene may include an image, a motion picture and a programmed background scene which are displayed in a predetermined area.

The background scene may be displayed in at least two or more images by alternating each other in time series.

The at least two or more images are displayed in a predetermined order or randomly.

The password trace data may include coordinate data to each image and the trace data may be generated from the user's touch on the touch screen while each image is being displayed in the background scene. This method may include the steps of: generating the trace data by the user's touch to the touch screen while one of the images is being displayed; comparing the trace data with the password trace data preliminarily stored to the image; and displaying the next image and continuing the generation of the trace data if the trace data is identical to the password trace data preliminarily stored to the image, successfully terminating the password admission if there is no more image, or terminating the password admission in failure for others.

This method may also include the steps of: displaying at least two or more images; selecting one from the displayed images by the user's touch; and displaying the selected image as a background scene on the touch screen.

This method may also include the steps of: divisionally setting the touch screen into a predetermined number of unit areas; and displaying background scenes on the divided touch screens.

This method may further include the step of displaying the background scene by enlarging, scaling down or moving it.

In an embodiment, a cursor may appear at a point where a user of the touch screen touches.

The trace data may include coordinate data of a point, at which the user touches on the touch screen, and touch order data, respectively

The trace data may include coordinate data of a point, at which the user touches on the touch screen, touch order data, and touch time data representing a length of touch time.

The trace data may include coordinate data of a point, at which the user touches on the touch screen, touch order data, and blank time data representing an interval between touches.

This method may include the step of executing a special menu if the trace data is identical to special menu trace data preliminarily stored.

According to the present invention, it is possible to provide a password input apparatus and method based on a touch screen without preparing an additional input unit such as a keypad or keyboard and other similar fixed pictures (by software).

And, it is also permissible to provide a password input method based on a touch screen, capable of coincidently achieving cryptographic key security and input convenience.

Furthermore, it is available for a password input method based on a touch screen to use a password input manner according to an advanced mode.

Meantime, a password input method based on a touch screen, according to the present invention, can provide a variety of tools for password input.

Additionally, it is allowable for a password input method based on a touch screen to induce an interest from a user when the user tries to enter a password.

And, a password input method based on a touch screen, according to the present invention, can be more ensured for password admission in response to a user's access to a corresponding menu.

Moreover, it is possible to provide a password input method based on a touch screen, capable of executing password admission in a flexible condition of a background scene with various tools by a user as well as enabling the user to easily set his own password necessary for the password admission.

A further understanding of the nature and advantages of the present invention herein may be realized by reference to the remaining portions of the specification and the attached drawings.

### BRIEF DESCRIPTION OF THE DRAWINGS

The present invention is illustrated by way of example, and not by way of limitation, in the figures of the accompanying drawings and in which like reference numbers refer to similar elements and in which:

FIG. 1 is a flow chart showing a password input method based on a touch screen according to a preferred embodiment of the present invention;

FIG. 2 illustrates a state of requiring a password while the background scene shown in FIG. 1 is being displayed on the touch screen;

FIG. 3 illustrates a state of generating trace data by contacting the touch screen while the background scene is being displayed;

FIG. 4 illustrates a state of admitting a password by comparing trace data, which accords to a change of coordinate at a contact point due to a user's touch on the touch screen, with password trace data while the background scene is being displayed;

FIG. 5 illustrates a state of enlarging, scaling down or moving the background scene while the background scene is being displayed;

FIG. 6 illustrates a state of, while an image is appearing on the touch screen, entering a password corresponding to the image and displaying the next image;

FIG. 7 illustrates a state of generating an additional cursor at a contact point by touching the touch screen while an image is appearing on the touch screen;

FIG. 8 illustrates a state of requiring the own password corresponding to a selected menu while the menu is being displayed on the touch screen; and

FIG. 9 illustrates a state of entering a password by touching or dragging a picture for a time while an image such as keyboard instrument is being displayed on the touch screen.

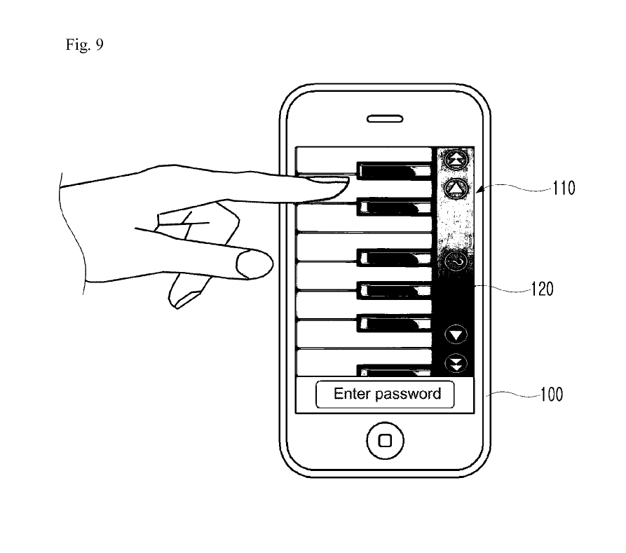

### DESCRIPTION OF EMBODIMENTS

Hereinafter, various exemplary embodiments will now be described more fully with reference to the accompanying drawings in which some exemplary embodiments are shown. However, specific structural and functional details disclosed herein are merely representative for purposes of describing exemplary embodiments of the present invention.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof

In order to more specifically describe exemplary embodiments for a password input method based on a touch screen, various aspects will be hereinafter described in detail with reference to the attached drawings.

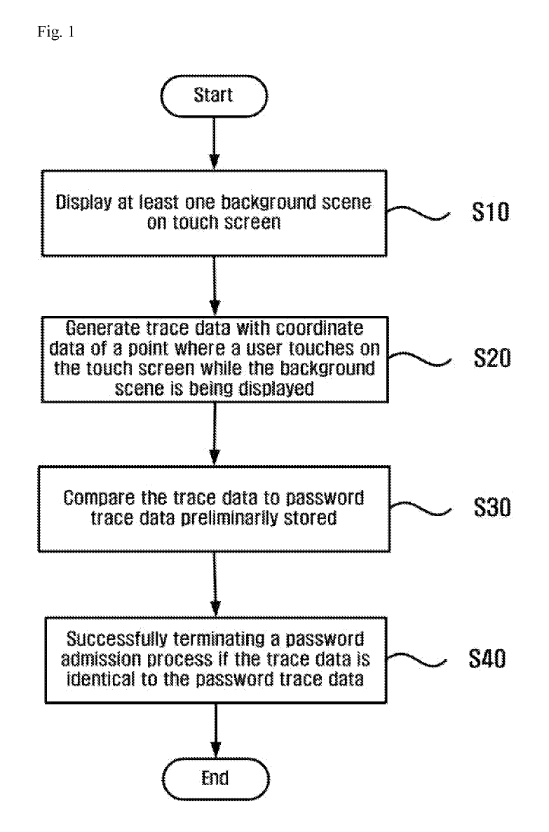

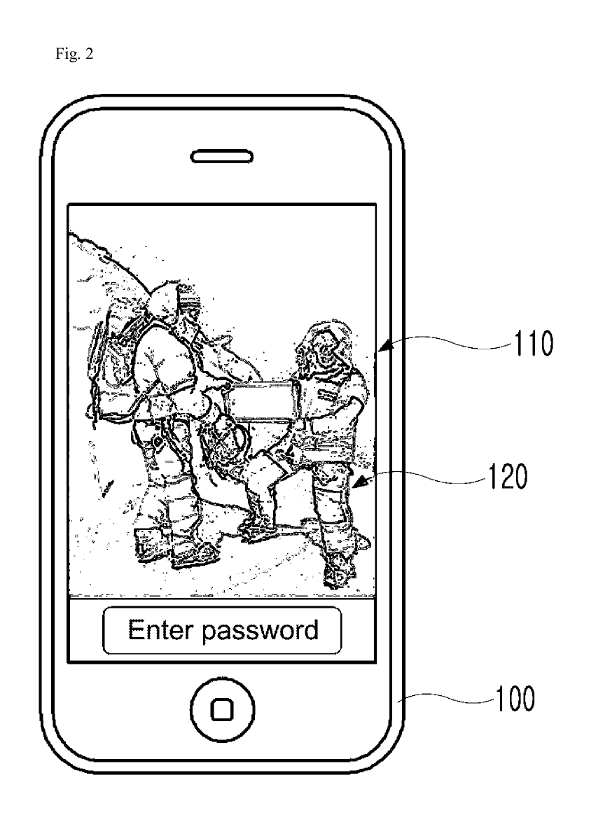

FIG. 1 is a flow chart showing a password input method based on a touch screen according to a preferred embodiment of the present invention, and FIG. 2 illustrates a state of requiring a password while the background scene shown in FIG. 1 is being displayed on the touch screen.

Referring to FIGS. 1 and 2, a password input method based on a touch screen is comprised of the following steps. First, an input of a password is required at background scene 120 of touch screen 110 equipped in electronic terminal 100. According as that, a user touches in a uniform path on at least one background scene 120 displayed in the touch screen 110. Then, trace data (i.e. trace data) generated this time is compared to password trace data corresponding to a password previously stored. If the trace data is identical to the password trace data, password admission proceeds to make the user be authorized as a valid user for the electronic terminal 100.

In detail, this methodological process is carried out in the steps of displaying at least one background scene, generating trace data from a user's touch on the touch screen while the background scene is being displayed, comparing the trace data to password trace data preliminarily stored, and successfully terminating a password admission process if the trace data is identical to the password trace data.

During this, a specific image appears at a predetermined area of the background scene 120. The displayed image may include a motion picture or a programmed background scene sensitive to a user's input. The programmed background scene means a background that includes an animation responding to a user's input, activates an operation providing a specific action or voice to induce a user's input, or providing a more interactive interface with s a specific action or voice responding to a user's input so as to make the user confirm and sense visually and audibly his input operation.

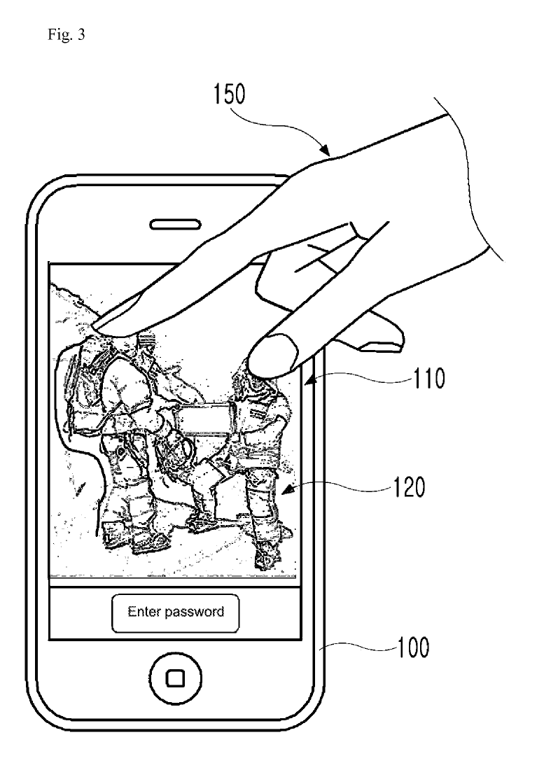

Referring to FIG. 3, a password input process using a touch screen, according to a preferred embodiment of the present invention, will be briefly described.

FIG. 3 illustrates a state of generating trace data by contacting the touch screen while the background scene is being displayed.

As shown in FIG. 3, when the electronic terminal 100 is turned on to activate the touch screen 110, the background scene 120 is displayed on the touch screen 110 and a window for requiring an input of password is open at a bottom side of the background scene 120.

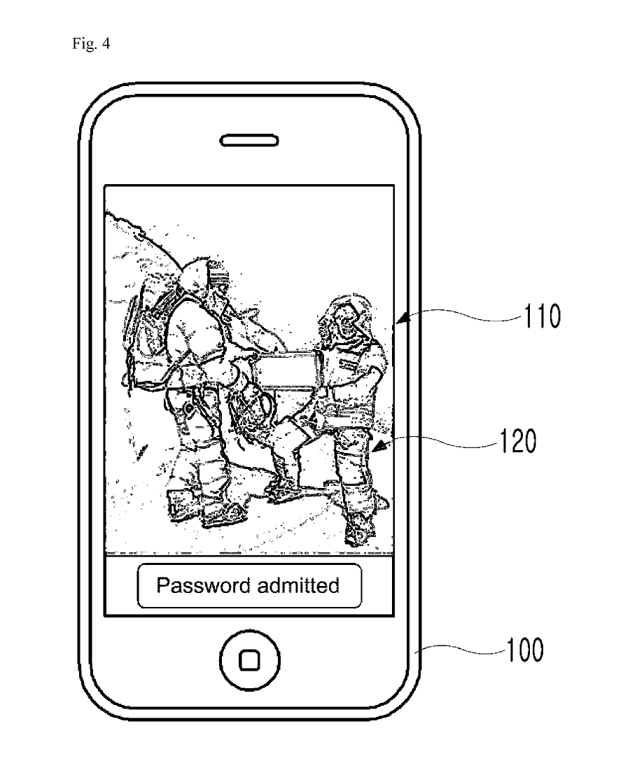

At this time, a user of the electronic terminal 100 usually enters a password by means of a writing tool such as touch pen, stylus pen, etc., or a finger. Different from those input ways with formalized characters key, in embodiments according to the present invention , password admission is carried out by touching along the same path with the password trace data that is ‘trace data of a touched point preliminarily set up’ to a specific image appearing on the background scene 120 (refer to FIG. 4).

Here, the password trace data as ‘trace data of a touched point preliminarily set up’ can be determined as follows.

As a password according to embodiments of the present invention is structured in a form of trace data, it is set up by, after activating a question window of “DO YOU WANT TO SET THE TRACE DATA AS PASSWORD” in a touched condition that a user conducts a dragging operation along a specific path or presses down a specific point on the background scene 120 displayed in the touch screen 110 of the electronic terminal 100, selecting “YES” to the question window.

Therefore, it is possible to update a previously determined password by, after activating a question window of “DO YOU WANT TO SET THE TRACE DATA AS PASSWORD” in a condition that a user touches randomly or along another path on the background scene 120 displayed in the touch screen 110 of the electronic terminal 100, selecting “YES” to the question window.

Additionally, a user of the electronic terminal 100 is able to enlarge or scale down the background scene 120 so as to make the password input easier or password setup more elaborate.

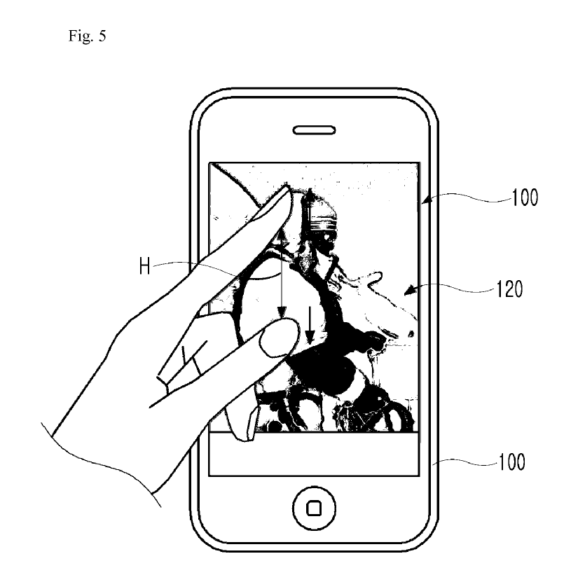

FIG. 5 illustrates a state of enlarging, scaling down or moving the background scene while the background scene is being displayed.

Referring to FIG. 5, while displaying the background scene 120 on the touch screen 110 of the electronic terminal 100, the background scene 120 can be enlarged by touching two points and distancing the two points, or scaled down by narrowing an interval between the two touched points. This is well known as used in the iPhone of

Apple Inc. and many kinds of touchable phones, so will not be described in further detail.

In the meantime, according to embodiments of the present invention, it is also permissible to from a scheme of password admission by displaying a multiplicity of images and inputting trace data respective to images appearing in time series, and after showing a plurality of images in a size of thumb nail, to input a password by displaying one image, which is selected by a user, on the background scene. In this case, since a part of the images may be set with passwords and other part of the images may not be set with passwords, it is possible to more enhance security for password input.

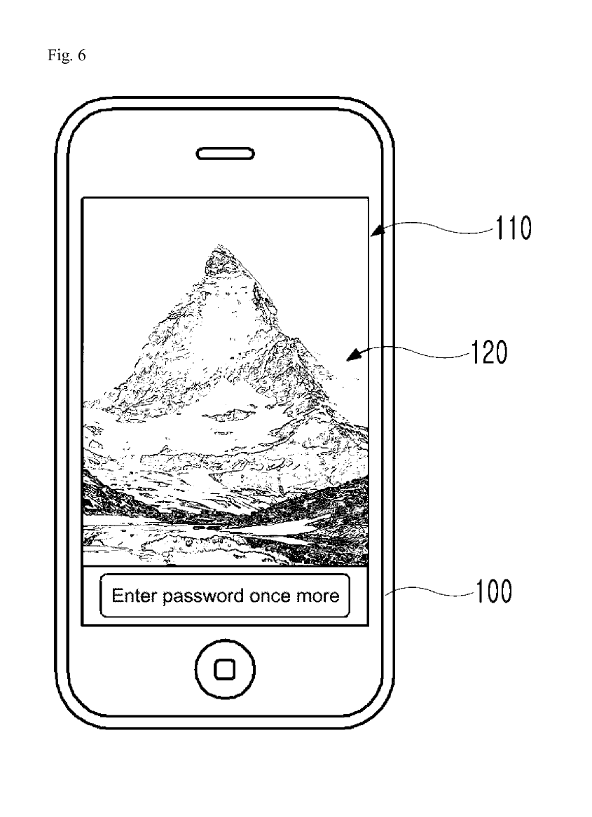

FIG. 6 illustrates a state of, while an image is appearing on the touch screen, entering a password corresponding to the image and displaying the next image.

Referring to FIG. 6, while plural images are appearing on the background scene 120, menus are not shown until a first password admission is successfully complete by touching along a path for password input in the condition of displaying one image and until another password admission is complete by touching one more time along a path for password input in the condition of activating a window of “ENTER PASSWORD ONCE MORE”, then a user can use the electronic terminal 100.

The plural images can be displayed in a predetermined order or randomly.

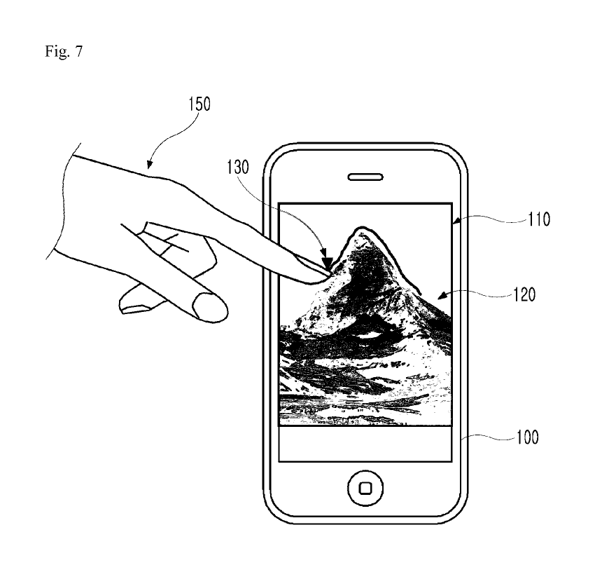

For the purpose of make a touch operation easier along a path, as shown in FIG. 7, a password input method according to embodiments of the present invention may be also implemented to additionally generate cursor 130 at a touched point by contacting the touch screen 110 while an image is being displayed on the touch screen 110.

Meanwhile, according to embodiments of the present invention, it is permissible to form a password admission mode even in a specific menu or the third party application displayed in the background scene 110 by providing an Application Programming Interface (API).

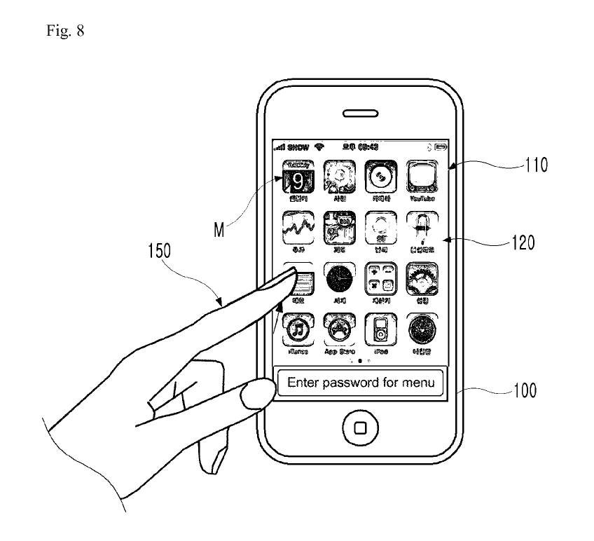

As illustrated in FIG. 8, password admission can be performed by requesting an input of the own password corresponding to menu M and contacting the touch screen 110 along the same path with the password trace data by a user. Thereby, it is possible to highly ensure user certification against an access to the special menu M, which needs private secrecy, such as “Diary” or “Address list”.

Moreover, according to embodiments of the present invention, it is also permissible to induce an interest along with higher security, when a user tries to set and enter a password, by offering keyboard 140 instrument with a multiplicity of fingerboards or plural percussion instruments at a predetermined area of a background scene and generating, when the user touches each fingerboard 141 or the percussions according to a tune or rhythm, trace data containing a pattern of the tune or rhythm. A user is able to input the trace data or the password trace data by rhythmically touching the fingerboards 141 in accordance with a background scene. During this, the trace data may include coordinate data of a point, at which the user touches on the touch screen, touch order data, touch time data representing a length of touch time, and blank time data representing an interval between touches. With this, it is possible to input trace data in a rhythm corresponding to long and short sound by touching points of the fingerboards. And, even a blank time can be a part of the trace data. In an embodiment of the present invention, if the background scene is formed in an instrument, it is also possible to output the instrument's sound through a speaker in accordance with a user's touch, as well as storing generating and storing trace data by the user's touch. With this embodiment, a user can set and input his own password by for example playing a snatch of “Endless rain” of X Japan in a drum background scene, a first code of a song named “morning dew” in a guitar background scene, or touching a rhythm corresponding to the cheering slogan “Dae˜HanMinGuk” in a palm background scene. Thus, the user feels an interest while entering the password, as well as maximizing a security level because a complex touchable password can be replaced with instrumental accompaniment that is accustomed to him.

Especially, according to embodiments of the present invention, a user is able to divide the touch screen 110 into a number of unit areas for the purpose of obtaining safely and easily trace data that is generated by his touch operation. And the user can also modify and then set the unit areas in need for himself

Furthermore, according to an embodiment of the present invention, for the purpose of providing a particular function that enables a user to use the electronic terminal 100 even when he forget his own password or enables another user, who is ignorant of a password, to use the electronic terminal 100, it is possible to activate a special menu function if there is a specific motion input through a motion sensor or a touch input with a specific pattern. The touch input with a specific pattern can be stored as a special menu trace data preliminarily determined and compared to trace data entered from a user to determine to execute the special menu function. During this, the special menu may be an emergency call such as “112”, “119”, etc., and a predetermined call number used when the electronic terminal 100 is lost.

The foregoing is illustrative of exemplary embodiments and is not to be construed as limiting thereof Although a few exemplary embodiments have been described, those skilled in the art will readily appreciate that many modifications are possible in exemplary embodiments without materially departing from the novel teachings and advantages. Accordingly, all such modifications are intended to be included within the scope of this invention as defined in the claims.

What is claimed is:

1. A password input method based on a touch screen, setting and inputting a password by a path from a user's touch on a touch screen, the method comprising:
inputting password trace data by the user's touch on a background scene set by a user and setting a password;
inputting trace data by the user's touch on the background scene;
comparing the trace data with the password trace data; and
successfully terminating password admission if the trace data is identical to the password trace data.

2. The method according to claim 1, wherein the background scene comprises an image, a motion picture and a programmed background scene which are displayed in a predetermined area.

3. The method according to claim 1, wherein inputting the password trace data comprises inputting the password trace data by a touch on each of at least two or more images;
wherein inputting the trace data comprises displaying one of al least two or more images and generating the trace data by the user's touch to the displayed image;
wherein comparing the trace data with the password trace data comprises comparing the trace data with the password trace data preliminarily stored to the displayed image; and
wherein successfully terminating the password admission comprises: if the trace data is identical to the password trace data preliminarily stored to the displayed image, displaying the next background scene and resuming the input of the trace data by the user's touch on the next background scene; if the next background scene is absent, successfully terminating the password admission; or terminating the password admission in failure for others.

4. The method according to claim 1, wherein inputting the trace data by the user's touch on the background scene comprises:
displaying at least two or more images;
selecting one from the displayed images by the user's touch; and
displaying the selected image as a background scene on the touch screen.

5. The method according to claim 1, wherein a cursor appears at a point where a user of the touch screen touches.

6. The method according to claim 1, wherein the password trace data and the trace data comprise coordinate data of a point, at which the user touches on the touch screen, and touch order data, respectively

7. The method according to claim 1, wherein the password trace data and the trace data each comprise coordinate data of a point, at which the user touches on the touch screen, touch order data, and touch time data representing a length of touch time.

8. The method according to claim 1, wherein the password trace data and the trace data each comprise coordinate data of a point, at which the user touches on the touch screen, touch order data, and blank time data representing an interval between touches.

9. The method according to claim 1, wherein comparing the trace data with the password trace data comprises executing a special menu if the trace data is identical to special menu trace data preliminarily stored.
